(19) United States
(12) Patent Application Publication
(10) Pub. No.: US 2011/0157229 A1
(43) Pub. Date: Jun. 30, 2011

(54) VIEW SYNTHESIS WITH HEURISTIC VIEW BLENDING

(76) Inventors: Zefeng Ni, Santa Barbara, CA (US); Dong Tian, Plainsboro, NJ (US); Sitaram Bhagavathy, Plainsboro, NJ (US); Joan Llach, Princeton, NJ (US)

(21) Appl. No.: 12/737,890

(22) PCT Filed: Aug. 28, 2009
(86) PCT No.: PCT/US2009/004924

§ 371 Date: Feb. 25, 2011

Related U.S. Application Data
(60) Provisional application No. 61/092,967, filed on Aug. 29, 2008.
(60) Provisional application No. 61/192,612, filed on Sep. 19, 2008.

(51) Int. Cl. G09G 5/00

(52) U.S. Cl. 345/646

(57) ABSTRACT

Various implementations are described. Several implementations relate to view synthesis with heuristic view blending for 3D Video (3DV) applications. According to one aspect, at least one reference picture, or a portion thereof, is warped from at least one reference view location to a virtual view location to produce at least one warped reference. A first candidate pixel and a second candidate pixel are identified in the at least one warped reference. The first candidate pixel and the second candidate pixel are candidates for a target pixel location in a virtual picture from the virtual view location. A value for a pixel at the target pixel location is determined based on values of the first and second candidate pixels.

### CROSS-REFERENCE TO RELATED APPLICATIONS

This application claims the benefit of both (1) U.S. Provisional Application Ser. No. 61/192,612, filed on Sep. 19, 2008, titled “View Synthesis with Boundary-Splatting and Heuristic View Merging for 3DV Applications”, and (2) U.S. Provisional Application Ser. No. 61/092,967, filed on Aug. 29, 2008, titled “View Synthesis with Adaptive Splatting for 3D Video (3DV) Applications”. The contents of both U.S. Provisional Applications are hereby incorporated by reference in their entirety for all purposes.

### TECHNICAL FIELD

Implementations are described that relate to coding systems. Various particular implementations relate to view synthesis with heuristic view blending for 3D Video (3DV) applications.

### BACKGROUND

Three dimensional video (3DV) is a new framework that includes a coded representation for multiple view video and depth information and targets, for example, the generation of high-quality 3D rendering at the receiver. This enables 3D visual experiences with auto-stereoscopic displays, free-view point applications, and stereoscopic displays. It is desirable to have further techniques for generating additional views.

### SUMMARY

According to a general aspect, at least one reference picture, or a portion thereof, is warped from at least one reference view location to a virtual view location to produce at least one warped reference. A first candidate pixel and a second candidate pixel are identified in the at least one warped reference. The first candidate pixel and the second candidate pixel are candidates for a target pixel location in a virtual picture from the virtual view location. A value for a pixel at the target pixel location is determined based on values of the first and second candidate pixels.

The details of one or more implementations are set forth in the accompanying drawings and the description below. Even if described in one particular manner, it should be clear that implementations may be configured or embodied in various manners. For example, an implementation may be performed as a method, or embodied as apparatus, such as, for example, an apparatus configured to perform a set of operations or an apparatus storing instructions for performing a set of operations, or embodied in a signal. Other aspects and features will become apparent from the following detailed description considered in conjunction with the accompanying drawings and the claims.

### BRIEF DESCRIPTION OF THE DRAWINGS

FIG. 1A is a diagram of an implementation of non-rectified view synthesis.

FIG. 1B is a diagram of an implementation of rectified view synthesis.

FIG. 2 is a diagram of an implementation of a view synthesizer.

FIG. 3 is a diagram of an implementation of a video transmission system.

FIG. 4 is a diagram of an implementation of a video receiving system.

FIG. 5 is a diagram of an implementation of a video processing device.

FIG. 6 is a diagram of an implementation of a system for transmitting and receiving multi-view video with depth information.

FIG. 7 is a diagram of an implementation of a view synthesis process.

FIG. 8 is a diagram of an implementation of a view blending process for a rectified view.

FIG. 9 is a diagram of an angle determined by 3D points Orᵢ-Pᵢ-Oₛ.

FIG. 10A is a diagram of an implementation of up-sampling for rectified views.

FIG. 10B is a diagram of an implementation of a blending process based on up-sampling and Z-buffering.

### DETAILED DESCRIPTION

Some 3DV applications impose strict limitations on the input views. The input views must typically be well rectified, such that a one dimensional (1D) disparity can describe how a pixel is displaced from one view to another.

Depth-Image-Based Rendering (DIBR) is a technique of view synthesis which uses a number of images captured from multiple calibrated cameras and associated per-pixel depth information. Conceptually, this view generation method can be understood as a two-step process: (1) 3D image warping; and (2) reconstruction and re-sampling. With respect to 3D image warping, depth data and associated camera parameters are used to un-project pixels from reference images to the proper 3D locations and re-project them onto the new image space. With respect to reconstruction and re-sampling, the same involves the determination of pixel values in the synthesized view.

The rendering method can be pixel-based (splatting) or mesh-based (triangular). For 3DV, per-pixel depth is typically estimated with passive computer vision techniques such as stereo rather than generated from laser range scanning or computer graphics models. Therefore, for real-time processing in 3DV, given only noisy depth information, pixel-based methods should be favored to avoid complex and computational expensive mesh generation since robust 3D triangulation (surface reconstruction) is a difficult geometry problem.

Existing splatting algorithms have achieved some very impressive results. However, they are designed to work with high precision depth and might not be adequate for low quality depth. In addition, there are aspects that many existing algorithms take for granted, such as a per-pixel normal surface or a point-cloud in 3D, which do not exist in 3DV. As such, new synthesis algorithms are desired to address these specific issues.

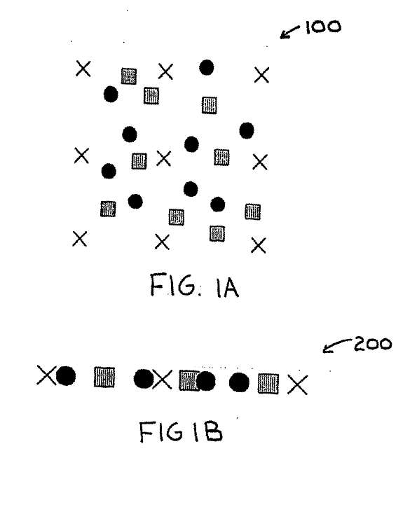

Given depth information and camera parameters, it is straightforward to warp reference pixels onto the synthesized view. The most significant problem is how to estimate pixel values in the target view from warped reference view pixels. FIGS. 1A and 1B illustrate this basic problem. FIG. 1A shows non-rectified view synthesis 100. FIG. 1B shows rectified view synthesis 150. In FIGS. 1A and 1B, the letter “X” represents a pixel in the target view that is to be estimated, and circles and squares represents pixels warped from different reference views, where the difference shapes indicates the difference reference views.

A simple method is to round the warped samples to its nearest pixel location in the destination view. When multiple pixels are mapped to the same location in the synthesized view, Z-buffering is a typical solution, i.e., the pixel closest to the camera is chosen. This strategy (rounding the nearest pixel location) can often result in pinholes in any surface that is slightly under-sampled, especially along object boundaries. The most common method to address this pinhole problem is to map one pixel in the reference view to several pixels in the target view. This process is called splatting.

If a reference pixel is mapped onto multiple surrounding target pixels in the target view, most of the pinholes can be eliminated. However, some image detail will be lost. The same trade-off between pinhole elimination and loss of detail occurs when using transparent splat-type reconstruction kernels. The question is: “how do we control the degree of splatting?” For example, for each warped pixel, shall we map it on all its surrounding target pixels or only map it to the one closest to it? This question is largely un-addressed in literatures.

When multiple reference views are employed, a common method will process the synthesis from each reference view separately and then merge multiple synthesized views together. The problem is how to merge them, for example, some sort of weighting scheme may be used. For example, different weights may be applied to different reference views based on the angular distance, image resolution, and so forth. Note that these problems should be addressed in a way that is robust to the noisy depth information.

Using DIBR, a virtual view can be generated from the captured views, also called as reference views in this context. It is a challenging task for the generation of a virtual view especially when the input depth information is noisy and no other scene information such as 3D surface property of the scene is known.

One of the most difficult problems is often how to estimate the value of each pixel in the synthesized view after the sample pixels in the reference views are warped. For example, for each target synthesized pixel, what reference pixels should be utilized, and how to combine them?

In at least one implementation, we propose a framework for view synthesis with heuristic view blending for 3DV applications. The inventors have noted that in 3DV applications (e.g., using DIBR) that involve the generation of a virtual view, such generation is a challenging task particularly when the input depth information is noisy and no other scene information such as a 3D surface property of the scene is known. The inventors have further noted that a prominent problem in generating such a virtual view is how to estimate the value of each pixel in the synthesize view after the sample pixels in the reference views are warped. For example, for each target synthesized pixel, what reference pixels should be utilized, and how to combine them?

Accordingly, in at least one implementation, we provide a heuristic method that blends multiple warped reference pixels based on, for example, their depth information, their warped 2D image positions and camera parameters. Of course, the present principles are not limited solely to the preceding and, thus, other items (information, positions, parameters, etc.) may be used to blend multiple warped reference pixels, while maintaining the spirit of the present principles. The proposed scheme has no constraints on how many reference views are used as input and can be applied no matter whether or not the cameras views are rectified.

In at least one implementation, we permit combining the single-view synthesis and merging into one single blending scheme.

Additionally, the inventors have noted that to synthesize a virtual view from reference views, three steps are generally needed, namely: (1) forward warping; (2) blending (single view synthesis and multi-view merging); and (3) hole-filling.

With respect to the warping step of the above mentioned three steps relating to synthesizing a virtual view from reference views, basically two options can be considered to exist with respect to how the warping results are processed, namely merging and blending.

With respect to merging, you can completely warp each view to form a final warped view for each reference. Then you can “merge” these final warped views to get a single really-final synthesized view. “Merging” would involve, e.g., picking between the N candidates (presuming there are N final warped views) or combining them in some way. Of course, it is to be appreciated that the number of candidates used to determine the target pixel value need not be the same as the number of warped views. That is, multiple candidates (or none at all) may come from a single view.

With respect to blending, you still warp each view, but you do not form a final warped view for each reference. By not going final, you preserve more options as you blend. This can be advantageous because in some cases different views may provide the best information for different portions of the synthesized target view. Hence, blending offers the flexibility to choose the right combination of information from different views at each pixel. Hence, merging can be considered as a special case of two-step blending wherein candidates from each view are first processed separately and then the results are combined.

Referring again to FIG. 1A, FIG. 1A can be taken to show the input to a typical blending operation because FIG. 1A includes pixels warped from different reference views (circles, and squares, respectively). In contrast, for a typical merging application, one would expect only to see either circles or squares, because each reference view would typically be warped separately and then processed to form a final warped view for the respective reference. The final warped views for the multiple references would then be combined in the typical merging application.

Returning back to blending, as one possible option/consideration relating to the same, you might not perform splatting because you do not want to fill all the holes yet. These and other options are readily determined by one of ordinary skill in this and related arts, while maintaining the spirit of the present principles.

Thus, it is to be appreciated that one or more embodiments of the present principles may be directed to merging, while other embodiments of the present principles may be directed to blending. Of course, further embodiments may involve a combination of merging and blending. Features and concepts discussed in this application may generally be applied to both blending and merging, even if discussed only in the context of only one of blending or merging. Given the teachings of the present principles provided herein, one of ordinary skill in this and related arts will readily contemplate various applications relating to merging and/or blending, while maintaining the spirit of the present principles.

It is to be appreciated that the present principles generally relate to communications systems and, more particularly, to wireless systems, e.g., terrestrial broadcast, cellular, Wireless-Fidelity (Wi-Fi), satellite, and so forth. It is to be further appreciated that the present principles may be implemented in, for example, an encoder, a decoder, a pre-processor, a post processor, a receiver (which may include one or more of the preceding). For example, in an application where it is desirable to generate a virtual image to use for encoding purposes, then the present principles may be implemented in an encoder. As a further example with respect to an encoder, such an encoder could be used to synthesize a virtual view to use to encode actual pictures from that virtual view location, or to encode pictures from a view location that is close to the virtual view location. In implementations involving two reference pictures, both may be encoded, along with a virtual picture corresponding to the virtual view. Of course, given the teachings of the present principles provided herein, one of ordinary skill in this and related arts will contemplate these and various other applications, as well as variations to the preceding described application, to which the present principles may be applied, while maintaining the spirit of the present principles.

Additionally, it is to be appreciated that while one or more embodiments are described herein with respect to the H.264/MPEG-4 AVC (AVC) Standard, the present principles are not limited solely to the same and, thus, given the teachings of the present principles provided herein, may be readily applied to multi-view video coding (MVC), current and future 3DV Standards, as well as other video coding standards, specifications, and/or recommendations, while maintaining the spirit of the present principles.

Note that “splatting” refers to the process of mapping one warped pixel from a reference view to several pixels in the target view.

Note that “depth information” is a general term referring to various kinds of information about depth. One type of depth information is a “depth map”, which generally refers to a per-pixel depth image. Other types of depth information include, for example, using a single depth value for each coded block rather than for each coded pixel.

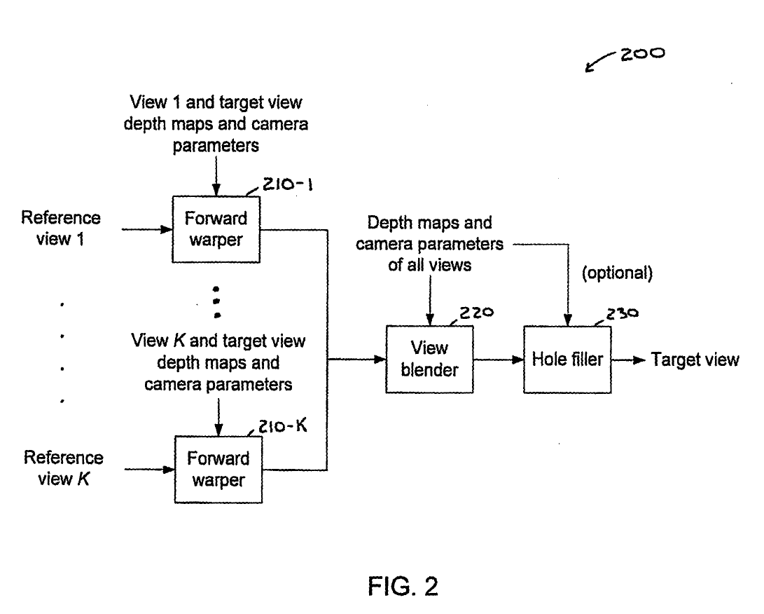

FIG. 2 shows an exemplary view synthesizer 200 to which the present principles may be applied, in accordance with an embodiment of the present principles. The view synthesizer 200 includes forward warpers 210-1 through 210-K, a view blender 220, and a hole filler 230. Respective outputs of forward warpers 210-1 through 210-K are connected in signal communication with a first input of the view blender 220. An output of the view blender 220 is connected in signal communication with a first input of hole filler 230. First respective inputs of forward warpers 210-1 through 210-K are available as inputs of the view synthesizer 200, for receiving respective reference views 1 through K. Second respective inputs of forward warpers 210-1 through 210-K are available as inputs of the view synthesizer 200, for respectively receiving view 1 and target view depths maps and camera parameters corresponding thereto, up through view K and target view depth maps and camera parameters corresponding thereto. A second input of the view blender 220 is available as an input of the view synthesizer, for receiving depth maps and camera parameters of all views. A second (optional) input of the hole filler 230 is available as an input of the view synthesizer 200, for receiving depth maps and camera parameters of all views. An output of the hole filler 230 is available as an output of the view synthesizer 200, for outputting a target view.

View blender 220 may perform one or more of a variety of functions and operations. For example, in an implementation, view blender 220 identifies a first candidate pixel and a second candidate pixel in the at least one warped reference, the first candidate pixel and the second candidate pixel being candidates for a target pixel location in a virtual picture from the virtual view location. Further, in the implementation, view blender 220 also determines a value for a pixel at the target pixel location based on values of the first and second candidate pixels.

Elements of FIG. 2, such as, for example, forward warpers 210 and view blender 220, may be implemented in various ways. For example, a software algorithm performing the functions of forward warping or view blending may be implemented on a general-purpose computer or on a dedicated-purpose machine such as, for example, a video encoder, or in a special-purpose integrated circuit (such as an application-specific integrated circuit (ASIC)). Implementations may also use a combination of software, hardware, and firmware. The general functions of forward warping and view blending are well known to one of ordinary skill in the art. Such general functions may be modified as described in this application to perform, for example, the forward warping and view blending operations described in this application.

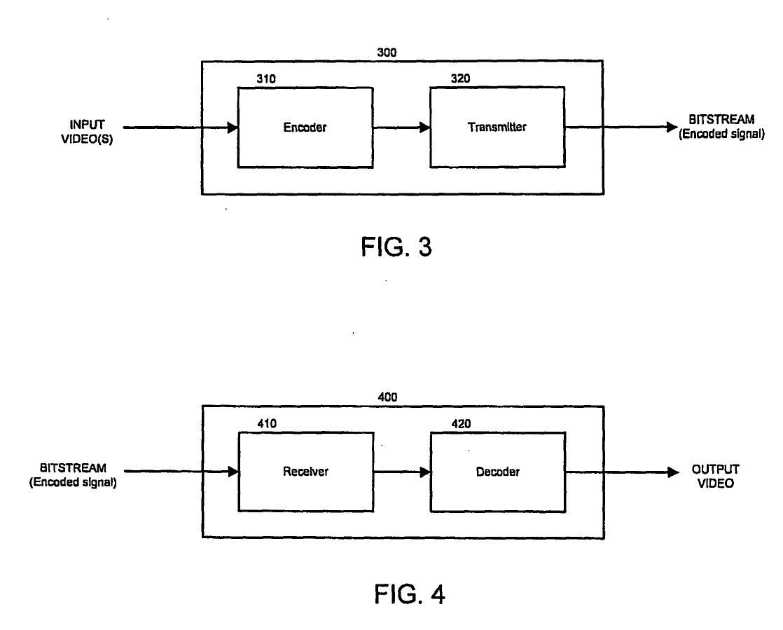

FIG. 3 shows an exemplary video transmission system 300 to which the present principles may be applied, in accordance with an implementation of the present principles. The video transmission system 300 may be, for example, a head-end or transmission system for transmitting a signal using any of a variety of media, such as, for example, satellite, cable, telephone-line, or terrestrial broadcast. The transmission may be provided over the Internet or some other network.

The video transmission system 300 is capable of generating and delivering video content encoded using inter-view skip mode with depth. This is achieved by generating an encoded signal(s) including depth information or information capable of being used to synthesize the depth information at a receiver end that may, for example, have a decoder.

The video transmission system 300 includes an encoder 310 and a transmitter 320 capable of transmitting the encoded signal. The encoder 310 receives video information and generates an encoded signal(s) there from using inter-view skip mode with depth. The encoder 310 may be, for example, an AVC encoder. The encoder 310 may include sub-modules, including for example an assembly unit for receiving and assembling various pieces of information into a structured format for storage or transmission. The various pieces of information may include, for example, coded or uncoded video, coded or uncoded depth information, and coded or uncoded elements such as, for example, motion vectors, coding mode indicators, and syntax elements.

The transmitter 320 may be, for example, adapted to transmit a program signal having one or more bitstreams representing encoded pictures and/or information related thereto. Typical transmitters perform functions such as, for example, one or more of providing error-correction coding, interleaving the data in the signal, randomizing the energy in the signal, and modulating the signal onto one or more carriers. The transmitter may include, or interface with, an antenna (not shown). Accordingly, implementations of the transmitter 320 may include, or be limited to, a modulator.

FIG. 4 shows an exemplary video receiving system 400 to which the present principles may be applied, in accordance with an embodiment of the present principles. The video receiving system 400 may be configured to receive signals over a variety of media, such as, for example, satellite, cable, telephone-line, or terrestrial broadcast. The signals may be received over the Internet or some other network.

The video receiving system 400 may be, for example, a cell-phone, a computer, a set-top box, a television, or other device that receives encoded video and provides, for example, decoded video for display to a user or for storage. Thus, the video receiving system 400 may provide its output to, for example, a screen of a television, a computer monitor, a computer (for storage, processing, or display), or some other storage, processing, or display device.

The video receiving system 400 is capable of receiving and processing video content including video information. The video receiving system 400 includes a receiver 410 capable of receiving an encoded signal, such as for example the signals described in the implementations of this application, and a decoder 420 capable of decoding the received signal.

The receiver 410 may be, for example, adapted to receive a program signal having a plurality of bitstreams representing encoded pictures. Typical receivers perform functions such as, for example, one or more of receiving a modulated and encoded data signal, demodulating the data signal from one or more carriers, de-randomizing the energy in the signal, de-interleaving the data in the signal, and error-correction decoding the signal. The receiver 410 may include, or interface with, an antenna (not shown). Implementations of the receiver 410 may include, or be limited to, a demodulator.

The decoder 420 outputs video signals including video information and depth information. The decoder 420 may be, for example, an AVC decoder.

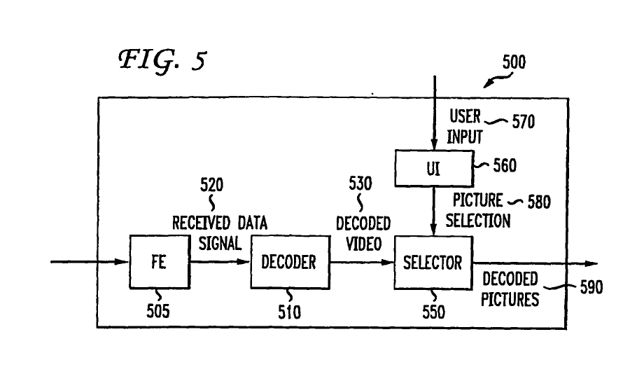

FIG. 5 shows an exemplary video processing device 500 to which the present principles may be applied, in accordance with an embodiment of the present principles. The video processing device 500 may be, for example, a set top box or other device that receives encoded video and provides, for example, decoded video for display to a user or for storage. Thus, the video processing device 500 may provide its output to a television, computer monitor, or a computer or other processing device.

The video processing device 500 includes a front-end (FE) device 505 and a decoder 510. The front-end device 505 may be, for example, a receiver adapted to receive a program signal having a plurality of bitstreams representing encoded pictures, and to select one or more bitstreams for decoding from the plurality of bitstreams. Typical receivers perform functions such as, for example, one or more of receiving a modulated and encoded data signal, demodulating the data signal, decoding one or more encodings (for example, channel coding and/or source coding) of the data signal, and/or error-correcting the data signal. The front-end device 505 may receive the program signal from, for example, an antenna (not shown). The front-end device 505 provides a received data signal to the decoder 510.

The decoder 510 receives a data signal 520. The data signal 520 may include, for example, one or more Advanced Video Coding (AVC), Scalable Video Coding (SVC), or Multi-view Video Coding (MVC) compatible streams.

AVC refers more specifically to the existing International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 Recommendation (hereinafter the “H.264/MPEG-4 AVC Standard” or variations thereof, such as the “AVC standard” or simply “AVC”).

MVC refers more specifically to a multi-view video coding (“MVC”) extension (Annex H) of the AVC standard, referred to as H.264/MPEG-4 AVC, MVC extension (the “MVC extension” or simply “MVC”).

SVC refers more specifically to a scalable video coding (“SVC”) extension (Annex G) of the AVC standard, referred to as H.264/MPEG-4 AVC, SVC extension (the “SVC extension” or simply “SVC”).

The decoder 510 decodes all or part of the received signal 520 and provides as output a decoded video signal 530. The decoded video 530 is provided to a selector 550. The device 500 also includes a user interface 560 that receives a user input 570. The user interface 560 provides a picture selection signal 580, based on the user input 570, to the selector 550. The picture selection signal 580 and the user input 570 indicate which of multiple pictures, sequences, scalable versions, views, or other selections of the available decoded data a user desires to have displayed. The selector 550 provides the selected picture(s) as an output 590. The selector 550 uses the picture selection information 580 to select which of the pictures in the decoded video 530 to provide as the output 590.

In various implementations, the selector 550 includes the user interface 560, and in other implementations no user interface 560 is needed because the selector 550 receives the user input 570 directly without a separate interface function being performed. The selector 550 may be implemented in software or as an integrated circuit, for example. In one implementation, the selector 550 is incorporated with the decoder 510, and in another implementation, the decoder 510, the selector 550, and the user interface 560 are all integrated.

In one application, front-end 505 receives a broadcast of various television shows and selects one for processing. The selection of one show is based on user input of a desired channel to watch. Although the user input to front-end device 505 is not shown in FIG. 5, front-end device 505 receives the user input 570. The front-end 505 receives the broadcast and processes the desired show by demodulating the relevant part of the broadcast spectrum, and decoding any outer encoding of the demodulated show. The front-end 505 provides the decoded show to the decoder 510. The decoder 510 is an integrated unit that includes devices 560 and 550. The decoder 510 thus receives the user input, which is a user-supplied indication of a desired view to watch in the show. The decoder 510 decodes the selected view, as well as any required reference pictures from other views, and provides the decoded view 590 for display on a television (not shown).

Continuing the above application, the user may desire to switch the view that is displayed and may then provide a new input to the decoder 510. After receiving a “view change” from the user, the decoder 510 decodes both the old view and the new view, as well as any views that are in between the old view and the new view. That is, the decoder 510 decodes any views that are taken from cameras that are physically located in between the camera taking the old view and the camera taking the new view. The front-end device 505 also receives the information identifying the old view, the new view, and the views in between. Such information may be provided, for example, by a controller (not shown in FIG. 5) having information about the locations of the views, or the decoder 510. Other implementations may use a front-end device that has a controller integrated with the front-end device.

The decoder 510 provides all of these decoded views as output 590. A post-processor (not shown in FIG. 5) interpolates between the views to provide a smooth transition from the old view to the new view, and displays this transition to the user. After transitioning to the new view, the post-processor informs (through one or more communication links not shown) the decoder 510 and the front-end device 505 that only the new view is desired. Thereafter, the decoder 510 only provides as output 590 the new view.

The system 500 may be used to receive multiple views of a sequence of images, and to present a single view for display, and to switch between the various views in a smooth manner. The smooth manner may involve interpolating between views to move to another view. Additionally, the system 500 may allow a user to rotate an object or scene, or otherwise to see a three-dimensional representation of an object or a scene. The rotation of the object, for example, may correspond to moving from view to view, and interpolating between the views to obtain a smooth transition between the views or simply to obtain a three-dimensional representation. That is, the user may “select” an interpolated view as the “view” that is to be displayed.

The elements of FIG. 2 may be incorporated at various locations in FIGS. 3-5. For example, one or more of the elements of FIG. 2 may be located in encoder 310 and decoder 420. As a further example, implementations of video processing device 500 may include one or more of the elements of FIG. 2 in decoder 510 or in the post-processor referred to in the discussion of FIG. 5 which interpolates between received views.

Returning to a description of the present principles and environments in which they may be applied, it is to be appreciated that advantageously, the present principles may be applied to 3D Video (3DV). 3D Video is a new framework that includes a coded representation for multiple view video and depth information and targets the generation of high-quality 3D rendering at the receiver. This enables 3D visual experiences with auto-multiscopic displays.

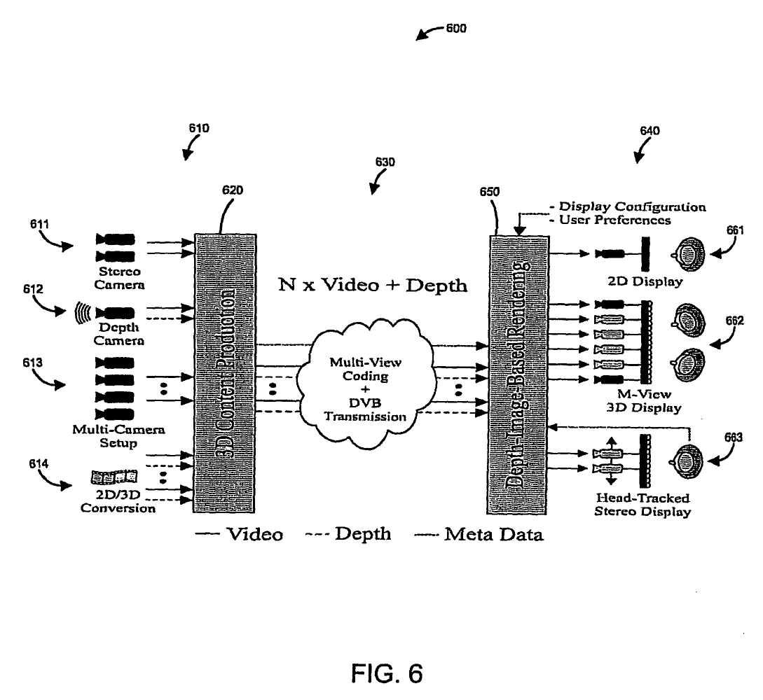

FIG. 6 shows an exemplary system 600 for transmitting and receiving multi-view video with depth information, to which the present principles may be applied, according to an embodiment of the present principles. In FIG. 6, video data is indicated by a solid line, depth data is indicated by a dashed line, and meta data is indicated by a dotted line. The system 600 may be, for example, but is not limited to, a free-viewpoint television system. At a transmitter side 610, the system 600 includes a three-dimensional (3D) content producer 620, having a plurality of inputs for receiving one or more of video, depth, and meta data from a respective plurality of sources. Such sources may include, but are not limited to, a stereo camera 611, a depth camera 612, a multi-camera setup 613, and 2-dimensional/3-dimensional (2D/3D) conversion processes 614. One or more networks 630 may be used for transmit one or more of video, depth, and meta data relating to multi-view video coding (MVC) and digital video broadcasting (DVB).

At a receiver side 640, a depth image-based renderer 650 performs depth image-based rendering to project the signal to various types of displays. This application scenario may impose specific constraints such as narrow angle acquisition (<20 degrees). The depth image-based renderer 650 is capable of receiving display configuration information and user preferences. An output of the depth image-based renderer 650 may be provided to one or more of a 2D display 661, an M-view 3D display 662, and/or a head-tracked stereo display 663.

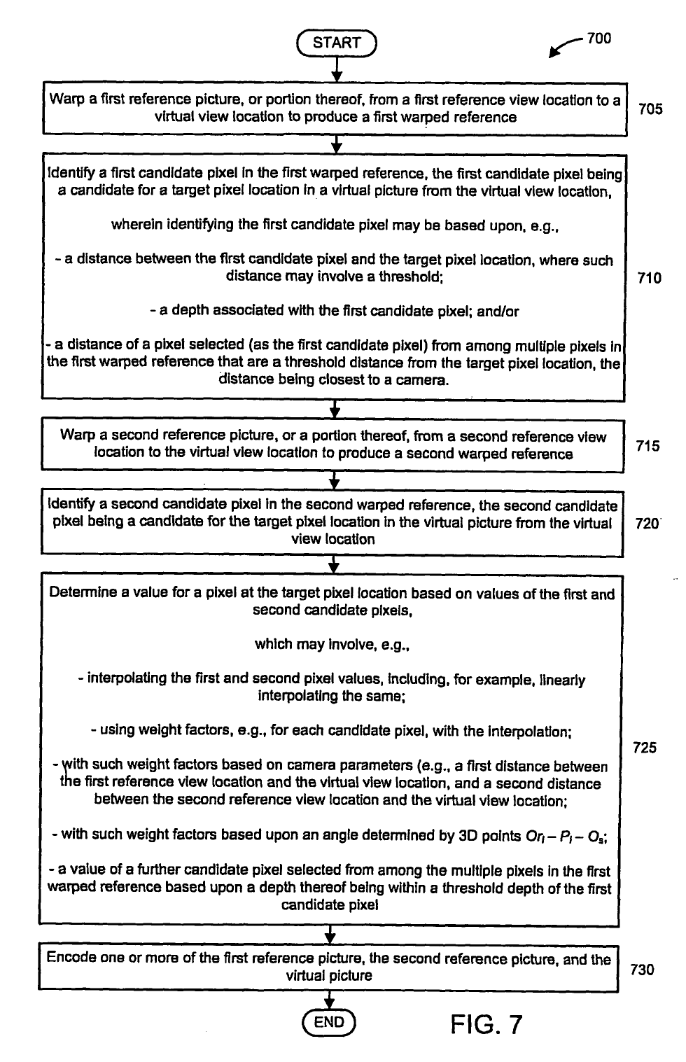

FIG. 7 shows a method 700 for view synthesis, in accordance with an embodiment of the present principles. At a step 705, a first reference picture, or a portion thereof, is warped from a first reference view location to a virtual view location to produce a first warped reference.

At step 710, a first candidate pixel in the first warped reference is identified. The first candidate pixel is a candidate for a target pixel location in a virtual picture from the virtual view location. It is to be appreciated that step 710 may involve, for example, identifying the first candidate pixel based on a distance between the first candidate pixel and the target pixel location, where such distance may optionally involve a threshold (e.g., the distance is below the threshold). Moreover, it is to be appreciated that step 710 may involve, for example, identifying the first candidate pixel based on depth associated with the first candidate pixel. Also, it is to be appreciated that step 710 may involve, for example, identifying the first candidate pixel based upon a distance of a pixel selected (as the first candidate pixel) from among multiple pixels in the first warped reference that are a threshold distance from the target pixel location, the distance being closest to a camera.

At step 715, a second reference picture, or a portion thereof, is warped from a second reference view location to the virtual view location to produce a second warped reference. At step 720, a second candidate pixel in the second warped reference is identified. The second candidate pixel is a candidate for the target pixel location in the virtual picture from the virtual view location.

At step 725, a value for a pixel at the target pixel location is determined based on values of the first and second candidate pixels. It is to be appreciated that step 725 may involve interpolating the first and second pixel values, including, for example, linearly interpolating the same. Moreover, it is to be appreciated that step 725 may involve using weight factors for example, for each of the candidate pixels. Such weight factors may be determined, for example, based on camera parameters that may involve, for example, a first distance between the first reference view location and the virtual view location, and a second distance between the second reference view location and the virtual view location. Also, such weight factors may be determined, for example, based upon an angle determined by 3D points Orᵢ-Pᵢ-Oₛ (as further described in detail with respect to embodiment 2 herein below). Additionally, it is to be appreciated that step 725 may also be based upon a value of a further candidate pixel selected from among the multiple pixels in the first warped reference (that are a threshold distance from the target pixel location) based upon a depth of the selected pixel being within a threshold depth of the first candidate pixel.

At step 730, one or more of the first reference picture, the second reference picture, and the virtual picture, are encoded.

It is to be appreciated that while the embodiment of FIG. 7 involves a first reference picture and a second reference picture, given the teachings of the present principles provided herein, one of ordinary skill in this and related arts will readily understand that the present principles are readily applicable to embodiments involving a single reference picture or more than two reference pictures, while maintaining the spirit of the present principles. As a further example of possible variations, in the case of a single reference picture, a single reference view location may be used to generate the first and second candidate pixels, with some changes to the warping process in order to obtain different values for the first and second candidate pixels despite the use of the same single reference view location. In other embodiments involving the case of a single reference picture, two or more (different) reference view locations may be used. These and other variations of the present principles are readily contemplated by one of ordinary skill in this and related arts, given the teachings of the present principles provided herein, while maintaining the spirit of the present principles.

As noted above, in at least one implementation, we provide a heuristic method that blends multiple warped reference pixels/views based on, for example, their depth information, their warped 2D image positions and camera parameters.

In 3DV applications, a reduced number of views plus depth maps are transmitted or stored due to a limitation in transmission bandwidth or storage constraints. As there is a desire to render virtual views in between the actual views, the technique of depth image based rendering (DIBR) can be used to generate the intermediate views.

To synthesize a virtual view from reference views, three steps are typically performed, namely: (1) forward warping; (2) blending (composition); and (3) hole-filling. In at least one implementation, a heuristic blending scheme is provided that addresses the issues caused by noisy depth information. Our simulations have showed superior quality is achieved compared to some existing schemes in 3DV.

### 1. Background Information—Forward Warping

The first step in performing view synthesis is forward warping, which includes finding, for each pixel in the reference views, its corresponding position in the target view. This 3D image warping is well known in computer graphics. Depending on whether input views are rectified or not, difference equations can be used.

### (a) Non-Rectified View

If we define a 3D point by its homogeneous coordinates P=[x, y, z, 1]^{T}, and its perspective projection in the reference image plane (i.e. 2D image location) is pᵣ=[uᵣ, vᵣ, 1]^{T}, then we have the following:

wᵣ·pᵣ=PPMᵣ·P, (1)

where wᵣ is the depth factor, and PPMᵣ is the 3×4 perspective projection matrix, known from the camera parameters. Correspondingly, we get the equation for the synthesized (target) view as follows:

wₛ·pₛ=PPMₛ·P. (2)

We denote the twelve elements of PPMᵣ as qᵢⱼ with i=1, 2, 3, and j=1, 2, 3, 4. From image point pᵣ and its depth z, the other two components of the 3D point P can be estimated by a linear equation as follows:

$$[ \begin{matrix}{a}_{11} & {a}_{12} \\ {a}_{21} & {a}_{22}\end{matrix} ] [ \begin{matrix}x \\ y\end{matrix} ] = [ \begin{matrix}{b}_{1} \\ {b}_{2}\end{matrix} ] , \\ with \\ {b}_{1} = ( {q}_{14} - {q}_{34} ) + ( {q}_{13} - {q}_{33} ) z , {a}_{11} = {u}_{r} {q}_{31} - {q}_{11} , {a}_{12} = {u}_{r} {q}_{32} - {q}_{12} . \\ {b}_{2} = ( {q}_{24} - {q}_{34} ) + ( {q}_{23} - {q}_{33} ) z , {a}_{21} = {v}_{r} {q}_{31} - {q}_{21} , {a}_{22} = {v}_{r} {q}_{32} - {q}_{22} . \qquad ( 3 )$$

Note that the input depth level of each pixel in the reference views is quantized to eight bits (i.e., 256 levels, where larger values mean closer to the camera) in 3DV. The depth factor z used during the warping is directly linked to its input depth level Y with the following formula:

$$z = \frac{1}{\frac{Y}{255} ( \frac{1}{{Z}_{near}} - \frac{1}{{Z}_{far}} ) + \frac{1}{{Z}_{far}}} , \qquad ( 4 )$$

where Zₙₑₐᵣ and Z_{far} correspond to the depth factor of the nearest pixel and the furthest pixel in the scene, respectively. When more (or less) than 8 bits are used to quantize depth information, the value 255 in equation (4) should be replaced by 2^{B}−1, where B is the bit depth.

When the 3D position of P is known, and we re-project it onto the synthesized image plane by Equation (2), we get its position in the target view pₛ (i.e. warped pixel position).

### (b) Rectified View

For rectified views, a 1-D disparity (typically along a horizontal line) describes how a pixel is displaced from one view to another. Assume the following camera parameters are given:
(i) f, focal length of the camera lens;
(ii) l, baseline spacing, also known as camera distance; and
(iii) du, difference in principal point offset.

Considering that the input views are well rectified, the following formula can be used to calculate the warped position pₛ=[uₛ, vₛ, 1]^{T} in the target view from the pixel pᵣ=[uᵣ, vᵣ, 1]^{T} in the reference view:

$${u}_{s} = {u}_{r} - \frac{f \cdot l}{z} + d u ; {v}_{s} = {v}_{r} . \qquad ( 5 )$$

### 2. Proposed Method: View Blending

The result of the view warping is illustrated in FIGS. 1A and 1B. In this step, the problem of how to estimate the pixel value in the target view (target pixel) from its surrounding warped reference pixels (candidate pixels) is addressed. In at least one implementation, as noted above, we provide a heuristic method that blends several warped reference pixels based on their depth information, warped pixel positions and camera parameters.

### Embodiment 1: Rectified Views

For simplification, rectified view synthesis is used as an example, i.e., estimate the target pixel value from the candidate pixels on the same horizontal line (FIG. 1B).

For each target pixel, warped pixels within ±a pixels distance from this target pixel are chosen as candidate pixels. The one with maximum depth level maxY (closest to the virtual camera) is found. Parameter a here is crucial. If it is too small, then pinholes will appear. If it is too large, then image details will be lost. It can be adjusted if some prior knowledge about the scene or input depth precision is known, e.g., using the variance of the depth noise. If nothing is known, value 1 works most of time.

In a typical Z-buffering algorithm, the candidate of maximum depth level (i.e., closest to the camera) will determine the pixel value at the target position. Here, the other candidate pixels are also kept as long as their depth levels are quite close to the maximum depth, i.e., (Y≧maxY−thresY), where thresY is a threshold parameter. In our experiments, thresY is set to 10. It could vary according to the magnitude of maxY or some prior knowledge about the precision of input depth. Let us denote by m the number of candidate pixels found so far.

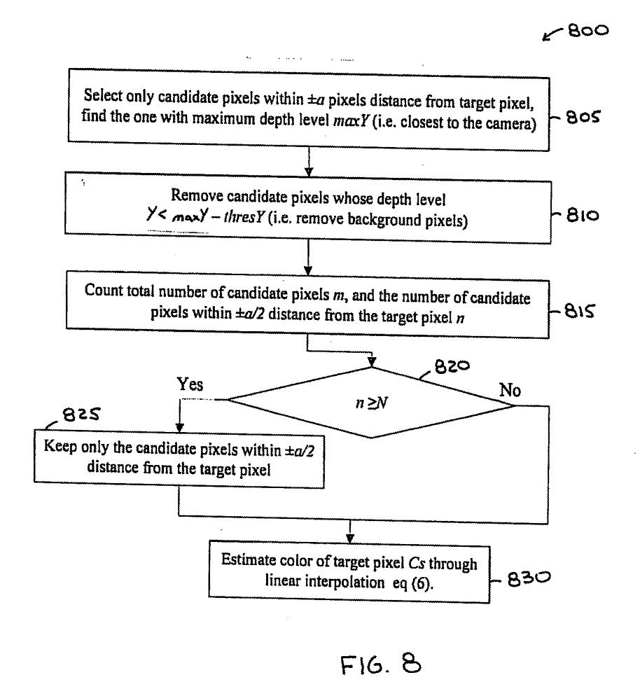

To further keep image details, if there are “enough” number of candidates within ±a/2 pixels distance from the target pixel, then only these candidates will be used to estimate the target pixel color. Let us define the number of such candidate pixels as n. To decide whether n is enough, difference criteria can be used, such as the following:
(i) If n≧N, i.e., if n is larger than a pre-set threshold N (we recommend setting it to 4 when thresY is set to 10 and there are two reference views). This is the criteria recommended as showed in FIG. 8.
   (ii) If m−n<M, i.e., if m is not significantly larger than n, with M as pre-set threshold.

Of course, the present principles are not limited to solely the preceding difference criteria and, thus, other difference criteria may also be used, while maintaining the spirit of the present principles.

After nₚ candidate pixels are selected, the next task is to interpolate the target pixel value Cₛ. Let us define the value of a candidate pixel i to be Cᵢ, which is warped from reference view rᵢ and the corresponding distance to the target pixel is dᵢ. We find that the following linear interpolation works very well:

$${C}_{s} = ( {\sum }_{i = 1}^{{n}_{p}} {w}_{i} \cdot {C}_{i} ) / {\sum }_{i = 1}^{{n}_{p}} {w}_{i} , with {w}_{i} = ( a - {d}_{i} ) \cdot W ( {r}_{i} , i ) , \qquad ( 6 )$$

where W(rᵢ,i) is the weight factor assigned to different views. It can be simply set to 1. For rectified views, we recommend setting it based on baseline spacing lᵣ (the camera distance between view rᵢ and the target view), e.g. W(rᵢ,i)=1/lᵣ.

FIG. 8 shows a proposed heuristic view blending process 800 for a rectified view, in accordance with an embodiment of the present principles. At step 805, only candidate pixels with ±a pixels distance from target pixel are selected, and the one with the maximum depth level maxY (i.e., closest to the camera) is selected. At step 810, the candidate pixels whose depth level Y<maxY−thresY are removed (i.e., remove background pixels). At step 815, the total number of candidate pixels m are counted, and the number of candidate pixels within ±a/2 distance from the target pixel n. At step 820, it is determined whether or not n≧N. If so, then control is passed to a step 825. Otherwise, control is passed to a step 830. At step 825, only the candidate pixels within ±a/2 distance from the target pixel are kept. At step 830, the color of target pixel Cs is estimated through linear interpolation per Equation (6).

### Embodiment 2: Non-Rectified Views

The blending scheme in FIG. 8 is easily extended to the case of non-rectified views. The only difference is that candidate pixels will not be on the same line of the target pixel (FIG. 1A). However, the same principle to select candidate pixels based on their depth and their distance to the target pixel can be applied.

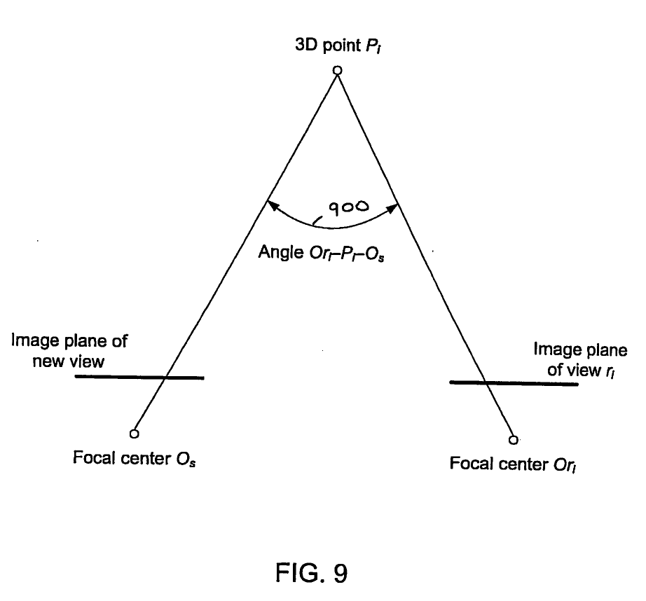

The same interpolation scheme, i.e., Equation (6), can also be used. For more precise weighting, W(rᵢ,i) can be further determined at the pixel level. For example, using the angle determined by 3D points Orᵢ-Pᵢ-Oₛ, where Pᵢ is the 3D position of the point corresponding to pixel I (estimated with Equation (3)), Orᵢ and Oₛ are the optic focal centers of the reference view rᵢ and the synthesized view respectively (known from camera parameters). We recommend setting W(rᵢ,i)=1/angle(Orᵢ-Pᵢ-Oₛ) or W(rᵢ,i)=cos^{q}(angle(Orᵢ-Pᵢ-Oₛ)), for q>2. FIG. 9 shows the angle 900 determined by 3D points Orᵢ-Pᵢ-Oₛ, in accordance with an embodiment of the present principles. Step 725 of method 700 of FIG. 7 shows the determination of weight factors based on angle 900, in accordance with one implementation.

### Embodiment 3: Approximation with Up-Sampling

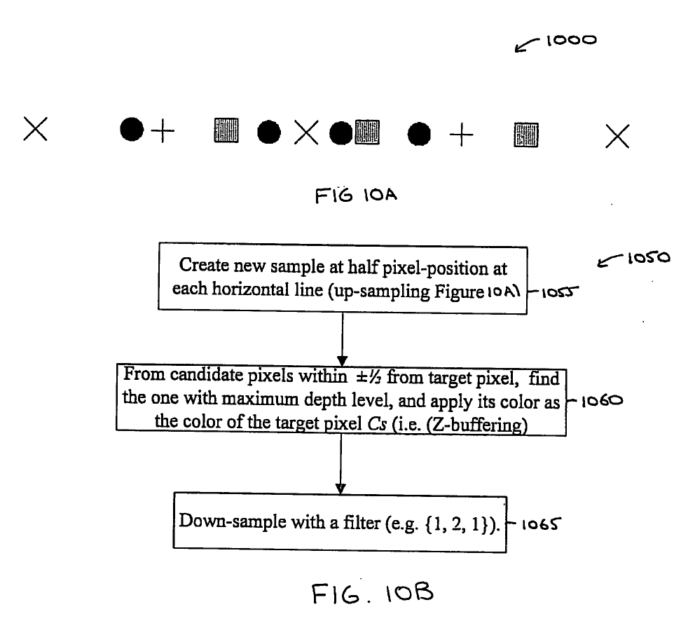

The schemes in the two previous embodiments might appear to be too complicated for some applications. There are ways to approximate them for fast implementation. FIG. 10A shows a simplified up-sampling implementation 1000 for the case of rectified views, in accordance with an embodiment of the present principles. In FIG. 10A, “+” represents new target pixels inserted at half-pixel positions. FIG. 10B shows a blending scheme 1050 based on Z-buffering, in accordance with an embodiment of the present principles. At step 1055, a new sample is created at a half-pixel position at each horizontal line (e.g., up-sampling per FIG. 10A). At step 1060, from candidate pixels within ±½ from the target pixel, the one with the maximum depth level is found and its color is applied as the color of the target pixel Cs (i.e., Z-buffering). At step 1065, down-sampling is per performed with a filer (e.g., {1, 2, 1}.

In the synthesized view, a new target pixel is first inserted at all half-pixel positions (FIG. 10A), i.e., up-sampling along the horizontal direction. Then for each target pixel, a simple Z-buffering scheme is applied to estimate its value. This is equivalent to setting thresY=0 in the generalized case (FIG. 8). To generate the final synthesized view, a simple down-sampling filter (e.g., {1, 2, 1}) is used. This filter approximates the weight wᵢ defined in Equation (6).

The same approach can also be applied for non-rectified views. The only difference is that the image is up-sampled along both horizontal and vertical directions.

It is to be appreciated that while one or more implementations are described with respect to half-pixels and half-pixel positions, the present principles are also readily applicable to any size sub-pixels (and, hence, corresponding sub-pixel positions), while maintaining the spirit of the present principles.

### Embodiment 4: Two-Step Blending

The blending schemes discussed thus far have no constraints on how many reference views are supplied as input although two reference views are typically used in 3DV. To make the proposed scheme easier for implementation, the proposed schemes can also be converted into two steps, i.e. synthesize a virtual image with each reference view separately (using, for example, any scheme mentioned above) and then merge all synthesized images together. For one implementation of Embodiment 3, the implementation merges using the up-sampled image and then down-samples the merged image.

For the merging part, a simple Z-buffering scheme can be used (i.e., with candidate pixels from different views, we pick the one closer to the camera). Alternatively, the weighting scheme mentioned above on W(rᵢ,i) can also be used. Of course, any other existing view-weighting scheme can be applied during the merging.

### 3. Post-Processing: Hole-Filling

Some pixels in the target view are never assigned a value during the blending step. These locations are called holes, often caused by dis-occlusions (previous invisible scene points in the reference views are uncovered in the synthesized view). The simplest approach is to examine pixels bordering the holes and use some of these bordering pixels to fill the holes. Since this step is unrelated to the proposed blending scheme, any existing hole-filling scheme can be applied.

Thus, in sum, in one or more implementations, we provide a heuristic blending scheme that: (1) selects candidate pixels based on their depth level and their warped image positions and (2) uses linear interpolation with weight factors determined by warped image positions and camera parameters.

Since our approach is heuristic, there could be many potential variations. For example, in Embodiments 1 and 2, only candidate pixels within ±a/2 pixels distance from target pixel are selected if there are enough of them. ½ is used for easy implementation. In fact it could be 1/k for any value k. On the other hand, one or more levels of selection can be added, e.g., find only candidate pixels within ±a/3, ±a/4, or ±a/6 distance from the target pixel, and so forth. Alternatively, to skip this step-by-step selection process, candidate pixels can be picked starting from the closest ones to the target pixel until there are enough of them. Another more generalized option is to cluster the candidate pixels based on their distances to the target pixel, and use the closest cluster as the candidate.

As another example, in Embodiment 3, the target view is up-sampled to a half-pixel position to approximate linear interpolation during the final down-sampling. At the expense of adding more complexity, more levels of up-sampling can be introduced to reach finer precision. In addition, the up-sampling level along the horizontal and vertical directions can be different.

We have described at least one implementation that warps at least one reference picture, or a portion thereof, from at least one reference view location to a virtual view location to produce at least one warped reference. Such an implementation identifies a first candidate pixel and a second candidate pixel in the at least one warped reference, the first candidate pixel and the second candidate pixel being candidates for a target pixel location in a virtual picture from the virtual view location. The implementation further determines a value for a pixel at the target pixel location based on values of the first and second candidate pixels. This implementation is amenable to many variations. For example, in a first variation, a single reference picture is warped to produce a single warped reference, from which two candidate pixels are obtained and used to determine the value for the pixel at the target pixel location. As another example, in a second variation, multiple reference pictures are warped to produce multiple warped references, and a single candidate pixel is obtained from each warped reference and used to determine the value for the pixel at the target pixel location.

We have thus described various implementations. In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. We thus provide one or more implementations having particular features and aspects. However, features and aspects of described implementations may also be adapted for other implementations. Accordingly, although implementations described herein may be described in a particular context, such descriptions should in no way be taken as limiting the features and concepts to such implementations or contexts.

Reference in the specification to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Implementations may signal information using a variety of techniques including, but not limited to, in-band information, out-of-band information, datastream data, implicit signaling, and explicit signaling. In-band information and explicit signaling may include, for various implementations and/or standards, slice headers, SEI messages, other high level syntax, and non-high-level syntax. Accordingly, although implementations described herein may be described in a particular context, such descriptions should in no way be taken as limiting the features and concepts to such implementations or contexts.

The implementations and features described herein may be used in the context of the MPEG-4 AVC Standard, or the MPEG-4 AVC Standard with the MVC extension, or the MPEG-4 AVC Standard with the SVC extension. However, these implementations and features may be used in the context of another standard and/or recommendation (existing or future), or in a context that does not involve a standard and/or recommendation.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding and decoding. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette, a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data blended or merged warped-reference-views, or an algorithm for blending or merging warped reference views. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application and are within the scope of the following claims.

1. A method comprising:
warping at least a portion of a first reference picture from a first reference view location to a virtual view location to produce a first warped reference;
warping at least a portion of a second reference picture from a second reference view location to the virtual view location to produce a second warped reference, wherein the second reference view location is different from the first reference view location;
identifying a first candidate pixel in the first warped reference and identifying a second candidate pixel in the second warped reference, the first candidate pixel and the second candidate pixel being candidates for a target pixel location in a virtual picture from the virtual view location; and
determining a value for a pixel at the target pixel location based on values of the first and second candidate pixels, wherein determining the value comprises interpolating a value for the target pixel from the first and second candidate pixel values using weight factors, for each of the first and second candidate pixels.

2. (canceled)

3. The method of claim 1, wherein the interpolating comprises linearly interpolating the value for the target pixel from the first and second candidate pixel values.

4. (canceled)

5. The method of claim 4, wherein the weight factors are determined by camera parameters.

6. The method of claim 1, wherein the weight factors are determined based upon a first distance and a second distance, the first distance being between the first reference view location and the virtual view location, and the second distance being between the second reference view location and the virtual view location.

7. The method of claim 1, wherein the weight factors are further determined by a distance between the first candidate pixel and the target pixel location.

8. The method of claim 1, wherein the weight factors are further determined by a depth associated with the first candidate pixel.

9. The method of claim 1, wherein identifying the first candidate pixel comprises identifying the first candidate pixel based on a distance between the first candidate pixel and the target pixel location.

10. The method of claim 9, wherein the distance is below a threshold.

11. The method of claim 1, wherein identifying the first candidate pixel comprises identifying the first candidate pixel based on depth associated with the first candidate pixel.

12. The method of claim 1, wherein identifying the first candidate pixel comprises selecting the first candidate pixel from multiple pixels in the first warped reference, and the multiple pixels are all within a threshold distance of the target pixel location, and the first candidate pixel is selected based on a depth of the first candidate pixel being closest to a camera.

13. The method of claim 12, further comprising selecting a further pixel from the multiple pixels as a further candidate pixel based on whether the further pixel has depth within a threshold of the depth of the first candidate pixel, and wherein determining the value for the pixel at the target pixel location is further based on a value of the further candidate pixel.

14. (canceled)

15. (canceled)

16. The method of claim 1, further comprising:
inserting a respective new target pixel at all sub-pixel positions in the virtual picture to obtain a plurality of respective new target pixels;
estimating a respective value for each of the plurality of respective new target pixels, based upon a respective depth associated with each of the first candidate pixel and the second candidate pixel; and
generating a final virtual view corresponding to the virtual picture using down-sampling.

17. The method of claim 16, wherein the inserting comprises further inserting a further respective new target pixel at all remaining sub-pixel positions in the virtual picture.

18. The method of claim 16, wherein estimating the respective value for each of the plurality of respective new target pixels is based upon the respective depth associated with each of the first candidate pixel and the second candidate pixel being closest to a camera.

19. The method of claim 1, further comprising, for each remaining target pixel location, different from the target pixel location, in the virtual picture:
identifying a first candidate, pixel for the remaining target pixel location from the first warped reference;
identifying a second candidate pixel for the remaining target pixel location from the second warped reference; and
determining a value for a pixel at the remaining target pixel location based on values of the first candidate pixel for the remaining target pixel location and the second candidate pixel for the remaining target pixel location.

20. The method of claim 1, further comprising encoding one or more of the first reference picture, the second reference picture, and the virtual picture.

21. (canceled)

22. An apparatus comprising:
means for warping at least a portion of a first reference picture, from a first reference view location to a virtual view location to produce a first warped reference;
means for warping at least a portion of a second reference picture from a second reference view location to the virtual view location to produce a second warped reference, wherein the second reference view location is different from the first reference view location;
means for identifying a first candidate pixel in the first warped reference and identifying a second candidate pixel in the second warped reference, the first candidate pixel and the second candidate pixel being candidates for a target pixel location in a virtual picture from the virtual view location; and
means for determining a value for a pixel at the target pixel location based on values of the first and second candidate pixels, wherein determining the value comprises interpolating a value for the target pixel from the first and second candidate pixel values using weight factors, for each of the first and second candidate pixels.

23. A processor readable medium having stored thereon instructions for causing a processor to perform at least the following:
warping at least a portion of a first reference picture from a first reference view location to a virtual view location to produce a first warped reference;
warping at least a portion of a second reference picture from a second reference view location to the virtual view location to produce a second warped reference, wherein the second reference view location is different from the first reference view location;
identifying a first candidate pixel in the first warped reference and identifying a second candidate pixel in the second warped reference, the first candidate pixel and the second candidate pixel being candidates for a target pixel location in a virtual picture from the virtual view location; and
determining a value for a pixel at the target pixel location based on values of the first and second candidate pixels, wherein determining the value comprises interpolating a value for the target pixel from the first and second candidate pixel values using weight factors, for each of the first and second candidate pixels.

24. An apparatus, comprising a processor configured to perform at least the following:
warping at least a portion of a first reference picture from a first reference view location to a virtual view location to produce a first warped reference;
warping at least a portion of a second reference picture from a second reference view location to the virtual view location to produce a second warped reference, wherein the second reference view location is different from the first reference view location;
identifying a first candidate pixel in the first warped reference and identifying a second candidate pixel in the second warped reference, the first candidate pixel and the second candidate pixel being candidates for a target pixel location in a virtual picture from the virtual view location; and
determining a value for a pixel at the target pixel location based on values of the first and second candidate pixels, wherein determining the value comprises interpolating a value for the target pixel from the first and second candidate pixel values using weight factors, for each of the first and second candidate pixels.

25. An apparatus comprising:
a forward warper for warping at least a portion of a first reference picture from a first reference view location to a virtual view location to produce a first warped reference, and for warping at least a portion of a second reference picture from a second reference view location to the virtual view location to produce a second warped reference, wherein the second reference view location is different from the first reference view location; and
a view blender for:
identifying a first candidate pixel in the first warped reference and identifying a second candidate pixel in the second warped reference, the first candidate pixel and the second candidate pixel being candidates for a target pixel location in a virtual picture from the virtual view location, and
determining a value for a pixel at the target pixel location based on values of the first and second candidate pixels, wherein determining the value comprises interpolating a value for the target pixel from the first and second candidate pixel values using weight factors, for each of the first and second candidate pixels.

26. The apparatus of claim 25, wherein the apparatus includes an encoder.

27. The apparatus of claim 25, wherein the apparatus includes a decoder.

28. An apparatus comprising:
a forward warper for warping at least a portion of a first reference picture from a first reference view location to a virtual view location to produce a first warped reference, and for warping at least a portion of a second reference picture from a second reference view location to the virtual view location to produce a second warped reference, wherein the second reference view location is different from the first reference view location;
a view blender for:
identifying a first candidate pixel in the first warped reference and identifying a second candidate pixel in the second warped reference, the first candidate pixel and the second candidate pixel being candidates for a target pixel location in a virtual picture from the virtual view location, and
determining a value for a pixel at the target pixel location based on values of the first and second candidate pixels, wherein determining the value comprises interpolating a value for the target pixel from the first and second candidate pixel values using weight factors, for each of the first and second candidate pixels; and
a modulator for modulating a signal, the signal including one or more of an encoding of the at least one reference picture and an encoding of the virtual picture.

29. An apparatus comprising:
a demodulator for demodulating a signal, the signal including one or more of at least one reference picture and a virtual picture;
a forward warper for warping at least a portion of a first reference picture from a first reference view location to a virtual view location to produce a first warped reference, and for warping at least a portion of a second reference picture from a second reference view location to the virtual view location to produce a second warped reference, wherein the second reference view location is different from the first reference view location; and
a view blender for:
identifying a first candidate pixel in the first warped reference and identifying a second candidate pixel in the second warped reference, the first candidate pixel and the second candidate pixel being candidates for a target pixel location in a virtual picture from the virtual view location, and
determining a value for a pixel at the target pixel location based on values of the first and second candidate pixels, wherein determining the value comprises interpolating a value for the target pixel from the first and second candidate pixel values using weight factors, for each of the first and second candidate pixels.
